(19) United States
(12) Patent Application Publication
(10) Pub. No.: US 2013/0305672 A1
(43) Pub. Date: Nov. 21, 2013

(54) Helical/Spiral Seal Air Filter

(71) Applicants: Jeremy Ryan ADKINS, Hope Mills, NC (US); Travis John FIFELSKI, Dorr, MI (US)

(72) Inventors: Jeremy Ryan ADKINS, Hope Mills, NC (US); Travis John FIFELSKI, Dorr, MI (US)

(73) Assignee: Purolator Filters NA LLC, Fayetteville, NC (US)

(21) Appl. No.: 13/473,218

(22) Filed: May 16, 2012

(51) Int. Cl. B01D 46/00; B23P 17/04

(52) U.S. Cl. 55/498; 29/428

(57) ABSTRACT

A fluid filter has an annular filter element and a particular annular seal, which has axial first and second surfaces, an outer circumferential surface, and an inner circumferential surface. The seal includes a sealing protrusion, defined by the axial first surface of the annular seal, with a section forming an axially oriented seal surface, as well as a filter element receptacle defined by the axial second surface. The receptacle receives an axial end of the annular filter element therein. To assist with installation, a feature defining a helix is included as part of the inner circumferential surface of the annular seal, and forms part of a radially oriented seal, surface.

### BACKGROUND OF THE INVENTION

1. Field of the Invention

This invention concerns fluid filters, useful in automotive applications, having features facilitating installation of filter elements into associated filter housings. While the fluid mentioned is typically air, the invention, of course, should not be considered limited solely to air filtering applications.

2. Description of Related Art

U.S. Pat. No. 5,547,480 to Coulonvaux discloses a cylindrical air filter including a ring-like end cap molded over ends of a cylindrical pleated paper filter element and liners between which that paper filter element is mounted. The end cap has a radially inward facing surface adapted to engage an outer surface of the tubular portion of an air filter outlet.

Conventional seals disposed between annular air filter elements and housings for such elements utilize axially extending sealing faces that either are cylindrical or have concentric rings. U.S. Pat. No. 5,556,440 to Mullins et al., for example, discloses several embodiments of a pressure-actuated radial air filter seal.

In one embodiment, the seal has a straight inside axial face that is deflected and placed in tension around a generally cylindrical center post, while, in another embodiment, the seal has an inside axial face with a concave radiused portion located between protruding radial ribs or lips that are deflected and placed in tension around the post.

The disclosures of both the Coulonvaux ('480) patent and the Mullins et al. ('440) patent are incorporated herein by reference as non-essential subject matter.

### SUMMARY OF THE INVENTION

A new end cap or seal design includes a helical or spiral feature on one of its sealing surfaces to ease installation. The helical or spiral feature is used instead of the usual concentric rings to produce a seal against the neck of an air filter housing outlet.

One aspect of the invention concerns a fluid filter having an annular filter element and a particular annular seal, which has axial first and second surfaces, an outer circumferential surface, and an inner circumferential surface. The seal includes a sealing protrusion, defined by the axial first surface of the annular seal, including a section forming an axially oriented seal surface, as well as a filter element receptacle defined by the axial second surface, the receptacle receiving an axial end of the annular filter element therein. A feature defining a helix is included as part of the inner circumferential surface of the annular seal and forms part of a radially oriented seal surface. In the particular embodiments described and illustrated, the helix referred to is a conical helix.

The feature mentioned could be a protruding thread, a ledge, or a step, and can extend either partially or completely along the axial extent of the inner circumferential surface of the annular seal. The invention, more generally, also relates to a filter arrangement for an automotive vehicle including a filter housing with an annular end wall and a neck forming a fluid outlet, and a fluid filter including an annular filter element and an annular seal such as that mentioned, as well as to a process of mounting the fluid filter in such a filter housing.

### BRIEF DESCRIPTION OF THE DRAWINGS

FIG. 1 is a perspective view from above an annular air filter seal according to a first embodiment of the invention.

FIG. 2 is a top view of the seal shown in FIG. 1.

FIG. 3 is a side view of the seal shown in FIG. 1.

FIG. 4 is a view of the seal shown in FIG. 2 along section line 4-4.

FIG. 5 is a part-sectional view similar to that provided by FIG. 4, but of a second embodiment of the air filter seal.

FIG. 6 is a view similar to that provided by FIG. 4, but of a third filter seal embodiment.

FIG. 7 is a part-sectional view similar to that provided by FIG. 4, but of a fourth filter seal embodiment.

FIG. 8 illustrates an air filter seal according to any of the four embodiments mentioned when the seal is located, in place, in the interior of a filter housing.

### DETAILED DESCRIPTION OF THE INVENTION

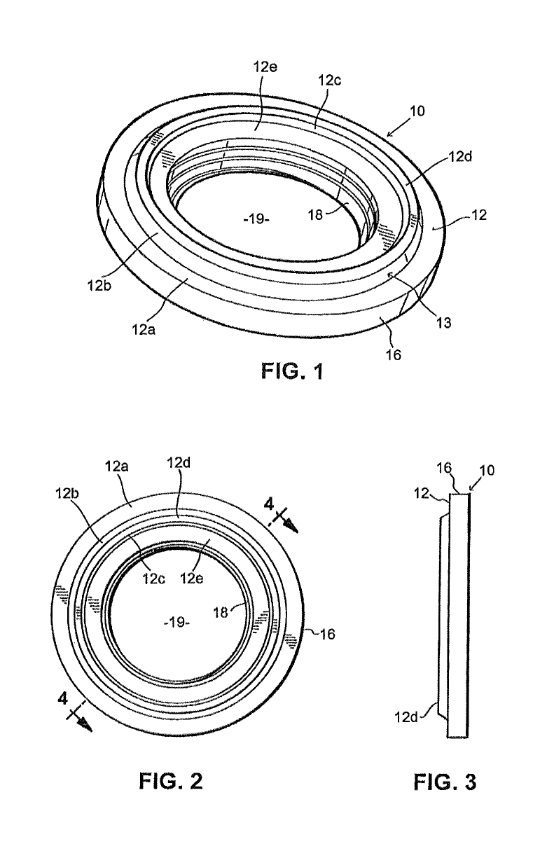

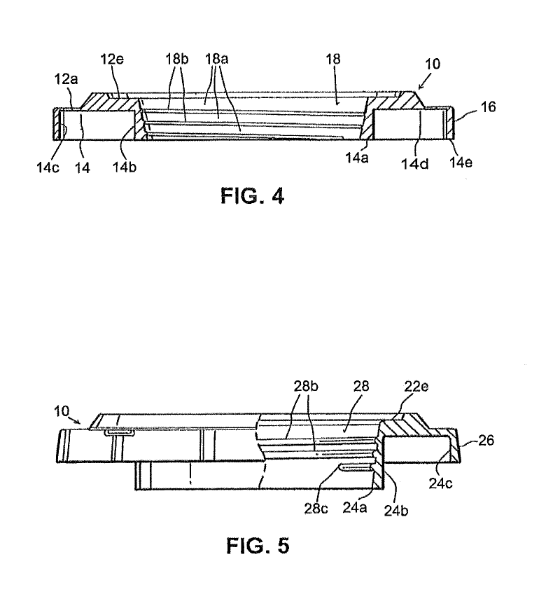

A first embodiment of an air filter seal 10 according to the invention is illustrated in FIGS. 1-4. This seal 10 may be a one piece elastomeric seal, a seal formed of another suitable material, or a seal formed of an appropriate combination of materials. The perspective view provided by FIG. 1 shows the seal to be generally annular overall. The seal 10 has an axial first surface 12, an axial second surface 14, best visible in FIG. 4, an outer circumferential surface 16, and an inner circumferential surface 18. The axial first surface 12 illustrated includes a radially outer flat section 12a, a first upstanding seal flange side section 12b, a second upstanding seal flange side section 12c, a substantially flat, axial seal flange sealing section 12d interposed between the seal flange side sections 12b and 12c, and a radially inner flat section 12e immediately adjacent a central opening 19 surrounded by the inner circumferential surface 18 of the seal 10.

Referring now to the cross sectional view provided by FIG. 4, the axial second surface 14 is composed of a substantially flat, radially inner annular section 14a immediately adjacent the central opening 19, a substantially cylindrical, axially extending section 14b adjacent to the inner annular section 14a, a substantially cylindrical, axially extending section 14c radially outside of and roughly parallel to the axially extending section 14b, a substantially flat, radially intermediate section 14d located between the axially extending sections 14b and 14c, and a radially outer annular section 14e defining an outer edge of the axial second surface 14. A sealing protrusion or flange 13 (FIG. 1) is delimited by the surface sections 12b, 12c, and 12d. Flat sections 12a and 12e may be positioned at the same distance from the intermediate section 14d of the surface 14, for a consistent thickness on opposite sides of the sealing protrusion or flange 13, or, as shown in FIG. 4, at different distances from the section 14d, so that the width or thickness of the seal 10 differs on opposite sides of the sealing protrusion or flange 13. In the first seal embodiment, the outer circumferential surface 16 of the seal 10 extends approximately axially between a radial outermost location of the outer flat section 12a and a radial outermost location of the annular section 14e, and thus is approximately cylindrical.

As shown in FIGS. 1, 2, and 4, the inner circumferential surface 18 of the annular seal 10 includes an approximately conical surface section 18a and a conical helix section 18b formed by a feature, such as the upstanding thread illustrated, protruding radially inwardly from the surface 18 relative to the section 18a. In the configuration shown in FIGS. 1-4, the thread section 18b is provided over the full axial extent of the surface 18, from the radially inner flat section 12e of the axial first surface 12 to the radially inner annular section 14a of the axial second surface 14. The thread section 18b may define a thread having a cross sectional shape that is semispherical, part oval, part triangular, part square, or part rectangular, or that is of any other suitable form.

FIG. 5 is a cross sectional view similar to that provided by FIG. 4, but of a second embodiment of the air filter seal 10. Reference numbers used in FIG. 5 to identify structures that are the same as, essentially the same as, or similar to structures discussed in connection with FIGS. 1-4 are increased by 10 relative to the reference numbers used in FIGS. 1-4. In the embodiment of FIG. 5, the inner substantially cylindrical, axially extending section 24b is elongated so as to differ significantly in axial extent from that of the outer substantially cylindrical, axially extending section 24c. An inwardly protruding thread section 28b of the inner circumferential surface 28, moreover, forms a conical helix extending only partially over the extent of that surface 28, with a termination point 28c that is axially displaced from the radially inner annular section 24a. The thread section 28b, again, may define a thread having a cross sectional shape that is semispherical, part oval, part triangular, part square, or part rectangular, or that is of any other suitable appropriate form. The outer circumferential surface 26 is shown in FIG. 5 as slightly conical, as opposed to the substantially cylindrical outer circumferential surface 16 illustrated in FIGS. 1-4.

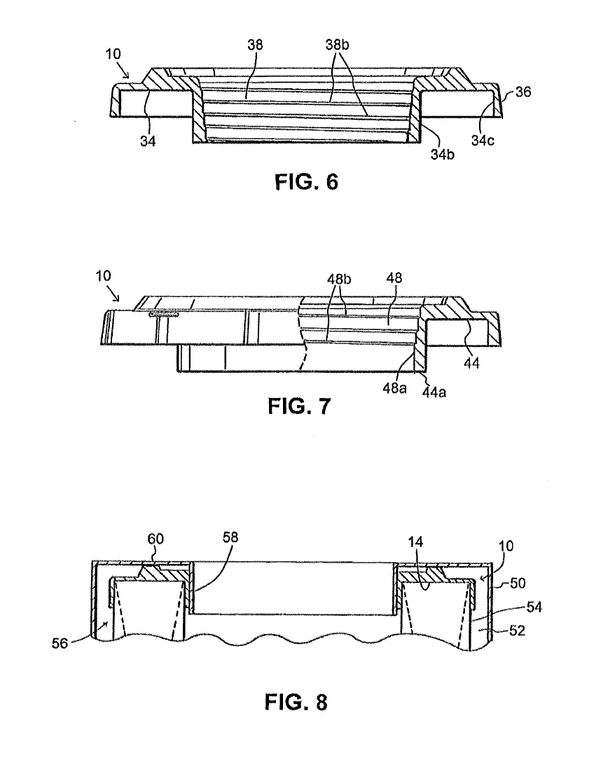

FIG. 6 is another cross sectional view similar to that provided by FIG. 4, but of a third filter seal embodiment. Reference numbers used in FIG. 6 to identify structures that are the same as, essentially the same as, or similar to structures discussed in connection with FIGS. 1-4 are increased by 20 relative to the reference numbers used in FIGS. 1-4. The seal 10 shown in FIG. 6 has an inner substantially cylindrical, axially extending section 34b of the axial second surface 34 that is similar to the section 24b of FIG. 5, in that it is significantly greater in axial extent than the outer substantially cylindrical, axially extending section 34c of the surface 34. Here, the helical feature is a ledge or step 38b, configured as a conical helix, that actually defines the inner circumferential surface 38 of the annular seal. The innermost corner of the ledge or step 38b, which may optionally be beveled, operates in a way, to be described, that is essentially the same as the conical helix thread sections 18b and 28b discussed in connection with FIGS. 1-4 and FIG. 5, respectively. The outer circumferential seal surface 36 shown in FIG. 6 is slightly conical, similar to the outer cylindrical surface 26 shown in FIG. 5.

FIG. 7 is yet another cross sectional view similar to that provided by FIG. 4, but of a fourth air filter seal embodiment. The seal 10 illustrated in FIG. 7 is nearly identical to that illustrated in FIG. 6, except that the ledge or step 48b, again configured as a conical helix and again defining the inner circumferential surface 48 of the annular seal, terminates at a location that is displaced from the substantially flat, radially inner annular section 44a of the axial second seal surface 44. Accordingly, the inner circumferential surface 48 includes an approximately cylindrical terminal portion 48a adjacent the annular section 44a mentioned.

FIG. 8 illustrates an air filter seal 10 according to any of the four embodiments mentioned when the seal is located, in place, in the interior 52 of a filter housing 50. Although the following discussion is equally applicable to each of the four embodiments mentioned above, to simplify this discussion, it will be presumed that the particular air filter seal 10 shown in FIG. 8 is a seal according to the first embodiment illustrated in FIGS. 1-4.

Referring now to both FIG. 1 and FIG. 8, when a filter element 54 and the seal 10 are assembled, sections 14b, 14c, and 14d of the axial second seal surface 14 are adhesively bonded or secured in some other fashion to an end of the element 54. Another seal, an end cap, or some other type of end support may be utilized at an end of the filter element 54 opposite that to which the seal 10 is secured, and appropriate liners (not shown) are provided to supply the overall filter 56 with adequate structural rigidity. The particular configuration of the filter element 54 itself does not matter in the context of the present invention; the element 54 could be formed of pleated fabric, for example, or of any other type of material appropriate for automotive air filtering applications.

Once the filter element 54 and the seal 10 are joined together and the overall filter 56 is ready for use, a neck 58 of the housing 50 and the central seal opening 19 are aligned, and both a torque (i.e., a twisting force) and an axial pressure or force are applied to at least one of the filter housing 50 and the filter 56 to rotate the seal 10 and, at the same time, displace the seal 10 relative to the neck 58 towards an end wall 60 of the filter housing. In one arrangement in which the invention is appropriate for use, the neck 58 forms an outlet for air that has been filtered upon passing through the element 54.

As the seal 10 is twisted and displaced relative to the neck 58 towards the end wall 60 of the filter housing, the neck forces the conical helix originally defined by the threads of the spiral thread section 18b to approach a strictly helical configuration, approximating threads of a screw, to facilitate interconnection between the seal 10 and the filter housing 50. The inner circumferential seal surface 18, including the surface and thread sections 18a and 18b, is at this time radially expanded and placed into tension, so that the thread section 18b and, to a slightly lesser degree, the surface section 18a press tightly against the annular outer surface of the neck 58 to form a radial seal. Under the combined action of the torque and the axially applied pressure or force, the inner surface 18 and the outer surface of the neck 58 are relatively rotated and relatively axially displaced until the sealing section 12d of the surface 12 is axially pressed against an end wall 54 of the filter housing 50 to a desired degree, thereby forming an axial seal. The necessary sealing between of the filter 56 and the filter housing 50 is thus automatically provided.

The foregoing disclosure has been set forth merely to illustrate the invention and is not intended to be limiting. Modifications of the disclosed embodiments incorporating the spirit and substance of the invention may occur to persons skilled in the art, and the invention should be construed to include everything within the scope of the invention ultimately claimed.

1. A fluid filter comprising:
an annular filter element,
an annular seal having axial first and second surfaces, an outer circumferential surface, and an inner circumferential surface,
a sealing protrusion defined by the axial first surface of the annular seal, the sealing protrusion including a section forming an axially oriented seal surface,
a filter element receptacle defined by the axial second surface, the receptacle receiving an axial end of the annular filter element therein, and
a feature defining a helix included as part of the inner circumferential surface of the annular seal, the feature forming part of a radially oriented seal surface.

2. The fluid filter of claim 1, wherein the helix is a conical helix.

3. The fluid filter of claim 1, wherein the feature is a protruding thread.

4. The fluid filter of claim 1, wherein the feature is a ledge or step.

5. The fluid filter of claim 1, wherein the feature extends only partially along an axial extent of the inner circumferential surface.

6. The fluid filter of claim 1, wherein the feature extends completely over an axial extent of the inner circumferential surface.

7. A filter arrangement for an automotive vehicle comprising:
a filter housing including an annular end wall and a neck forming a fluid outlet,
a fluid filter including an annular filter element, an annular seal having axial first and second surfaces, an outer circumferential surface, and an inner circumferential surface, a sealing protrusion defined by the axial first surface of the annular seal, the sealing protrusion including a section forming an axially oriented seal surface, a filter element receptacle defined by the axial second surface, the receptacle receiving an axial end of the annular filter element therein, and a feature defining a helix included as part of the inner circumferential surface of the annular seal, the feature forming part of a radially oriented seal surface,
wherein the axially oriented seal surface presses against the annular end wall of the filter housing to provide axial sealing between the filter housing and the fluid filter, and the radially oriented seal surface presses against an outer surface of the neck to provide radial sealing between the filter housing and the fluid filter.

8. The filter arrangement of claim 7, wherein the helix is a conical helix.

9. The filter arrangement of claim 7, wherein the filter element receptacle is defined by substantially parallel, substantially cylindrical, axially extending sections of the axial second surface and an intermediate section located between the substantially cylindrical, axially extending sections.

10. The filter arrangement of claim 7, wherein the feature is a protruding thread.

11. The filter arrangement of claim 7, wherein the feature is a ledge or step.

12. The filter arrangement of claim 7, wherein the feature extends only partially along an axial extent of the inner circumferential surface.

13. The filter arrangement of claim 7, wherein the feature extends completely over an axial extent of the inner circumferential surface.

14. A process of mounting a fluid filter in a filter housing, comprising:
providing (a) an annular seal having axial first and second surfaces, an outer circumferential surface, and an inner circumferential surface, a sealing protrusion being defined by the axial first surface of the annular seal, the sealing protrusion including a section forming an axially oriented seal surface, a filter element receptacle being defined by the axial second surface, and a feature defining a helix being included as part of the inner circumferential surface of the annular seal, the feature forming part of a radially oriented seal surface, and (b) an annular filter element having an axial end received within the receptacle, as the fluid filter,
aligning a neck of the filter housing, forming a fluid outlet, and a central opening of the annular seal surrounded by the inner circumferential surface, and
inserting the fluid filter into the filter housing by applying both a torque and an axial force to at least one of the fluid filter and the filter housing.

15. The process of claim 14, wherein the helix is a conical helix.
